(19) United States
(12) Patent Application Publication
(10) Pub. No.: US 2003/0038837 A1
(43) Pub. Date: Feb. 27, 2003

(54) Method for controlling a computer display

(75) Inventor: Lucas Lopatin, Buenos Aires (AR)

Correspondence Address: DARBY & DARBY P.C., Post Office Box 5257, New York, NY, 10150-5257, US

(73) Assignee: United Virtualities, Inc., New York, NY (US)

(21) Appl. No.: 10/186,338

(22) Filed: Jun. 27, 2002

Related U.S. Application Data
(60) Provisional application No. 60/301,396, filed on Jun. 27, 2001.

(51) Int. Cl. G09G 5/00

(52) U.S. Cl. 345/738

(57) ABSTRACT

HTML code is delivered in a received message or browser window which causes an invisible window to be created. More precisely, the window is at a coordinate which is beyond the coordinates on the computer screen and, therefore, is not visible to the user. The invisible window executes additional HTML code or may draw it through the Internet from a remote cite. The additional HTML code may produce further, invisible windows, which may be animated, and are independent of anything which appears on the computer screen. For example, the user may be presented a window on his screen which offers a free stock ticker, in exchange for being presented with periodic commercial messages.

This patent application claims the priority of U.S. Provisional Patent Application No. 60/301,396 filed Jun. 27, 2001, the entirety of which is incorporated herein by reference.

### FIELD OF THE INVENTION

The present invention relates generally to a method for controlling a computer display and, more particularly, relates to a method for controlling a computer display with information received from outside the computer.

### BACKGROUND OF THE INVENTION

Just as computer networks have gained widespread use in business, the Internet (one example of a computer network) has gained widespread use in virtually every aspect of our lives, owing primarily to the popularity of the worldwide web. The Internet includes servers (computers), which offer electrical communication to client computers (operated by users) and other servers. The computers involved may range from mainframes to cellular telephones, and they may operate over any conceivable communication medium.

Most users connect to the Internet (or “surf the net”) through a personal computer running an operating system with a graphic user interface (GUI), such as one of the Windows® operating systems. A user communicates over the Internet using a program called a “browser” running on his computer, the two most popular ones being Internet Explorer and Netscape, although many other browsers are in common use. The browser receives files in a format known as HTML, which is a mark-up language that permits multimedia to be embedded within formatted and stylized text, and it displays “pages”, which may play sound and exhibit graphics and video. Various programming languages, such as Javascript, are also available which permit executable code to be embedded in an HTML file and to run and to perform useful tasks when a browser presents the file to the user. Those skilled in the art will appreciate that browsers are not limited to use on the Internet, but are now widely used for general communication on networks, including Intranets.

The widest use of the Internet today is probably as a medium for electronic mail (“e-mail”). Few people living in modern societies today are not aware what e-mail is, if they are not actively making use of it.

Users of the Internet are quite familiar with the variety of services it makes available without charge. They are also quite familiar with the various forms of intrusive advertising which appear on the Internet, but typically they are willing to accept a certain amount of intrusion in exchange for the free services or software. Until the present invention, acquiring such service and/or advertising has required the use of a browser, an e-mail program, a plug-in, or some form of agent.

In order to move on to a new dimension in computer communication, it would be desirable, without the use of any plug-ins or agents to: (i) Originate an object in a window, such as a window of received e-mail or web browser and seemingly allow the object to exit from the window; (ii) Seemingly produce an object which is independent of any and all windows; and (iii) Provide a transactional environment which is independent of any web page or e-mail. The present invention makes all of this possible.

In accordance with the present invention, HTML code which is delivered in a received message or browser window causes an invisible window to be created. More precisely, the window is at a coordinate which is beyond the coordinates of the computer screen and, therefore, is not visible to the user. The invisible window executes additional HTML code or may draw it through the Internet from a remote cite. The additional HTML code may produce further, invisible windows, which may be animated, and are independent of anything which appears on the computer screen. For example, the user may be presented a window on his screen which offers a free stock ticker, in exchange for being presented with periodic commercial messages.

### BRIEF DESCRIPTION OF THE DRAWINGS

The foregoing brief description, as well as further objects, features, and advantages of the present invention will be understood for more completely from the following detailed description of presently preferred, but nonetheless illustrative, embodiments in accordance with the present invention, with reference being had to the accompanying drawings, in which:

FIG. 1 is a flow chart illustrating the method of the invention as embodied in the provision of a window presenting an independent, operational environment for communicating with a computer user.

### DETAILED DESCRIPTION OF THE PREFERRED EMBODIMENTS

A preferred embodiment of the invention is realized in a computer running under the WINDOWS operating system and utilizing OUTLOOK EXPRESS as the e-mail program. However, it will be appreciated that the invention operates equally well from an HTML web page on a browser, such as Internet Explorer.

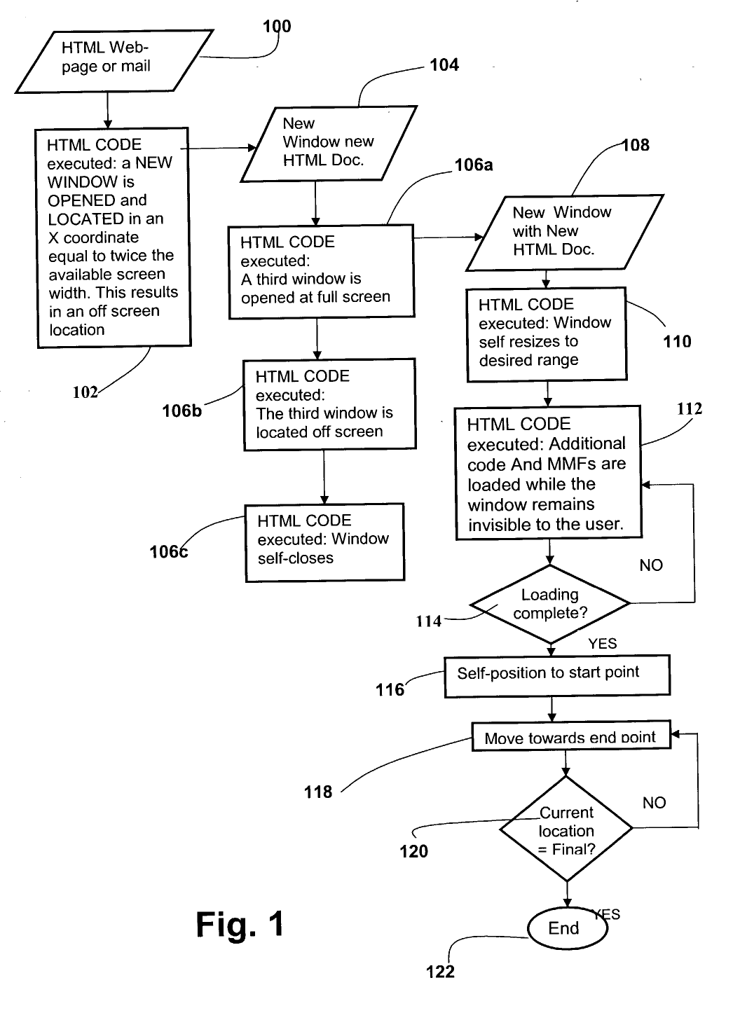

FIG. 1 is a flow chart illustrating a preferred embodiment of the method of the present invention. An e-mail containing HTML code is received by OUTLOOK EXPRESS in block 100. OUTLOOK EXPRESS is an HTML enabled e-mail program so the embedded HTML code is executed in block 102. Preferably, this is done through a Javascript, which uses a “window open” command. A new (second) window 104 is opened at coordinates which are off the screen. This “invisible” window contains additional HTML code which may be loaded from a remote site identified by an address provided in the script. The additional HTML code is executed at blocks 106a, 106b and 106c, respectively.

At block 106a, a new (third) window 108 is opened at full screen. This means that the window has its entire space filled with information and contains no borders. This can be achieved through a script command such as:

Name=window.open(“http://www.URLADRESS.com”, “name”, “fullscreen=1”)

This opens a new window having the “name”, makes the window full screen in the sense described above, and draws additional code and information from the indicated web site.

At block 106b, additional HTML code is executed in window 104 which locates window 108 off the screen and, finally, at block 106c, additional code is executed in window 104 which causes that window to self close.

Execution of the HTML code in window 108 begins at block 110, where the window is caused to resize to a desired size. Then, at block 112, additional code is downloaded while the window remains off screen. At block 114, a test is made to determine whether loading is complete and, if not, it continues. When loading is complete, the window repositions itself to a location on the visible screen, (block 116). Then, at block 118, window 108 begins to move itself towards an end point defined in the code. This can be accomplished through code such as:

MoveTo (Xposition, Yposition).

At block 120, a test is performed to determine whether the window has reached the final position defined in its code, and if not, control returns to block 118, where movement continues. When the test at block 120 indicates that the window has reached its final position, the executable code terminates at block 122.

Summarizing the disclosed embodiment, HTML code was presented in an e-mail, which caused a full screen window to open on the computer screen, out of the control of the user, and no apparent relationship to any window. Because it is full screen and has no borders, this window looks like an object rather than a window. It may also be desirable to make a part of the window, preferably a peripheral portion, transparent, so that it has the shape of an object, rather than a rectangle. The object/window moved around on the screen out of the control of the user and had no relationship to any other window, coming to rest on its own.

From the preceding description, it will be appreciated that the disclosed embodiment could achieve such features as:

1. Simulating the exit of a character from the confines of a window;

2. Landing a button off of a window;

3. Simulating a new proprietary button on the navigational bar;

4. Preserving a button even after the window containing it is closed.

5. Calling attention to a brand, message, signature, etc. . . . and

6. Creating a transactional environment (secure or not) that functions independently of the window being viewed by the user.

In the simple example presented, the second window 104 was used only for the purpose of launching the third window 108 and closed itself after the third window is opened. Similarly, the third window was merely a full screen window which, presumably presented some useful information or, alternately, could provide a web site link when clicked upon. In a more interesting example, the third window might remain in a fixed, convenient location on a computer screen and might provide such useful information as a stock ticker. Also, the second window 104 would not close itself, but would remain open. Periodically, it could access an Internet web site and download commercial messages which would be presented briefly on the computer screen. Thus, the user is provided a useful and desirable service in exchange for viewing periodic commercial messages.

Other useful services could be offered through the third window, such as an auction watch which informs the computer owner when he has been outbid in an auction, or an e-mail notification informing a computer user when new e-mail has been received by his e-mail program. However, it should be appreciated that these services are only exemplary and many other services could be offered in the same or similar manner.

In the disclosed embodiment, the e-mail program was OUTLOOK EXPRESS, which executes scripts. Other e-mail programs, such as OUTLOOK 2000 do not execute scripts. When such an e-mail program is utilized, the second window is opened and its additional HTML code is downloaded through the us of a java applet, which is downloaded from a server. This applet runs in a java virtual machine. Thus, as was the case with the first embodiment, it is not necessary to run a browser program, plug-in, or any kind of agent in order to realize the invention.

Although preferred embodiments of the invention have been disclosed for illustrative purposes, those skilled in the art will appreciate that many additions, modifications and substitutions are possible, without departing from the scope and spirit of the invention as defined by the accompanying claims.

What is claimed is:

1. A method for controlling a display of a user's computer connected to a computer network, the user's computer running an web browser program in a windowed operating system providing a graphic user interface, the method comprising the steps of:
delivering to the user's computer first executable code in an electronic communication over the network, the first executable code being structured to produce a control window on the user's computer at display coordinates that are not visible on the display of the user's computer, and to cause the execution of second executable code on the user's computer structured to produce a second window for display to the user; and
executing the first executable code at the user's computer to produce said control window and to cause the display of said second window.

2. The method of claim 1, wherein the first executable code is further structured to cause the second executable code to be acquired over the network prior to executing of the same.

3. The method of claim 1, wherein the executable code is embedded in HTML code provided in the electronic communication.

4. The method of claim 3 performed in a user's computer running an HTML enabled e-mail program, the electronic communication being an e-mail message.

5. The method of claim 1, wherein the second executable code initially produces the second window at display coordinates that are not visible on the display of the user's computer and then repositions it to coordinates that are visible on the user's display, whereby the second window seems to appear suddenly on the display, independently of any other window.

6. The method of claim 5, wherein the second window has its entire space filled with information and has no borders.

7. The method of claim 6, wherein a part of the second window is made transparent, so that the window may have the shape of an object that is not rectangular.

8. The method of claim 5, wherein the second executable code is structured to cause further code to be loaded to the second window over the network before the second window is repositioned.

9. The method of claim 5, wherein the second executable code causes the second window to move towards a predefined display position after repositioning it.

10. The method of claim 9, wherein the second window is initially repositioned inside another window and the predefined display position is outside the another window.

11. The method of claim 1, wherein after the second window is created, a portion of the second executable code remains in the control window which can be executed to acquire further executable code over the network.

12. The method of claim 11, wherein the further executable code provides a transaction environment over the network between the user's computer and another computer.

13. The method of claim 11, wherein the further executable code is constructed to activate periodically to communicate over the network.

14. The method of claim 13, wherein the communication causes a remotely created message to be displayed in a visible window on the user's computer.
